(19) United States
(12) Patent Application Publication
(10) Pub. No.: US 2007/0036548 A1
(43) Pub. Date: Feb. 15, 2007

(54) System with a distributed optical performance monitor for use in optical networks

(76) Inventors: Xiaodong Duan, Fremont, CA (US); Xiaofeng Yan, Fremont, CA (US); Giovanni Barbarossa, Saratoga, CA (US)

Correspondence Address: PATTERSON & SHERIDAN, LLP, 3040 POST OAK BLVD, SUITE 1500, HOUSTON, TX, 77095, US

(21) Appl. No.: 11/546,075

(22) Filed: Oct. 11, 2006

Related U.S. Application Data
(62) Division of application No. 10/642,479, filed on Aug. 15, 2003.

(51) Int. Cl. H04J 14/02

(52) U.S. Cl. 398/83

(57) ABSTRACT

An OADM structure is disclosed with distributed optical performance monitor cells that utilize drop channels for OSNR measurement. The OSNR measurement is computed by calculating the electric noise spectrum density from the Fast Fourier Transform of a sample spectrum and from a frequency range based on traffic protocol and transmission rate, as well as considering the average optical power of the sample points.

### CROSS-REFERENCE TO RELATED APPLICATIONS

This application is a divisional of co-pending U.S. patent application Ser. No. 10/642,479, filed Aug. 15, 2003, which is herein incorporated by reference.

### BACKGROUND OF THE INVENTION

1. Field of the Invention

The invention relates to the field of communication systems, and more particularly to performance monitoring in a metro or long-haul network.

2. Description of the Related Art

Dramatic turning events in the optical industry in recently years have not deterred the advancement in research and development of superior optical networks but the scale-back in investments and the shrinking markets have steered innovative solutions that leverage on the existing network infrastructures without compounding the overall expenses. Wavelength Division Multiplexing (WDM) is a popular technique to carry a plurality of channels where each light-wave-propagated information channel corresponds to light within a specific wavelength range or “band.” Multiple information channels are independently transmitted over the same fiber using multiple wavelengths of light that may arrive at their destinations through different optical paths. As a result, the optical signal-to-noise ratios of the WDM channels could be different from one another.

One conventional solution performs a whole-band monitoring using optical devices like tunable filters. Current optical performance monitors are capable of scanning the whole C band and L band, thereby providing power and optical signal noise ratio (OSNR) for all channels. A shortcoming in the whole-band monitoring is the high cost barrier for deploying applications in a metro network, as well as that it falls short in optimizing operations in a metro network.

Another conventional solution uses a channel-based monitor in a SONET ring infrastructure. The bit error rate (BER) monitoring of real traffic operates reliably in this framework. However, the necessity to decode SONET frames requires the use of expensive high-speed SONET chips.

Accordingly, there is a need to design a system and method for monitoring the performance of each channel without incurring additional overhead.

### SUMMARY OF THE INVENTION

The invention discloses an OADM structure with distributed optical performance monitor cells that utilizes drop channels for OSNR measurement. The OSNR measurement is computed by calculating the electric noise spectrum density from the Fast Fourier Transform of a sample spectrum and from a frequency range based on traffic protocol and transmission rate, as well as a consideration of the average sample points.

A method for distributed optical performance monitoring in a network comprises: selecting a frequency range based on the traffic protocol and transmission rate; sampling a plurality of points continuously at a frequency; computing the average optical power of the plurality of points; computing a Fast Fourier Transform to obtain a spectrum in frequency domain; computing a noise spectrum density from the spectrum and the frequency range; and computing an optical signal noise ratio (OSNR) from the noise spectrum density and the average sampled points.

Advantageously, the present invention leverages on the existing hardware design of the power monitor and OSNR monitor for OSNR without incurring additional optical components costs.

Other structures and methods are disclosed in the detailed description below. This summary does not purport to define the invention. The invention is defined by the claims.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an architectural diagram illustrating the deployment of optical add/drop multiplexers and optical performance monitors in a SONET ring of a metro network in accordance with the present invention.

FIG. 2 depicts a block diagram illustrating a smart optical add/drop multiplexer employing performance monitor cells in accordance with the present invention.

FIG. 3 depicts a block diagram illustrating a system that employs four performance monitor cells and the elements therein in accordance with the present invention.

FIG. 4 depicts a flow diagram illustrating the operational steps in a performance monitor cell in accordance with the present invention.

FIG. 5 depicts a flow diagram illustrating the operational steps in computing the noise power density in accordance with the present invention.

FIG. 6 depicts a graphical diagram illustrating the electrical spectrum of an optical channel in accordance with the present invention.

### DETAILED DESCRIPTION

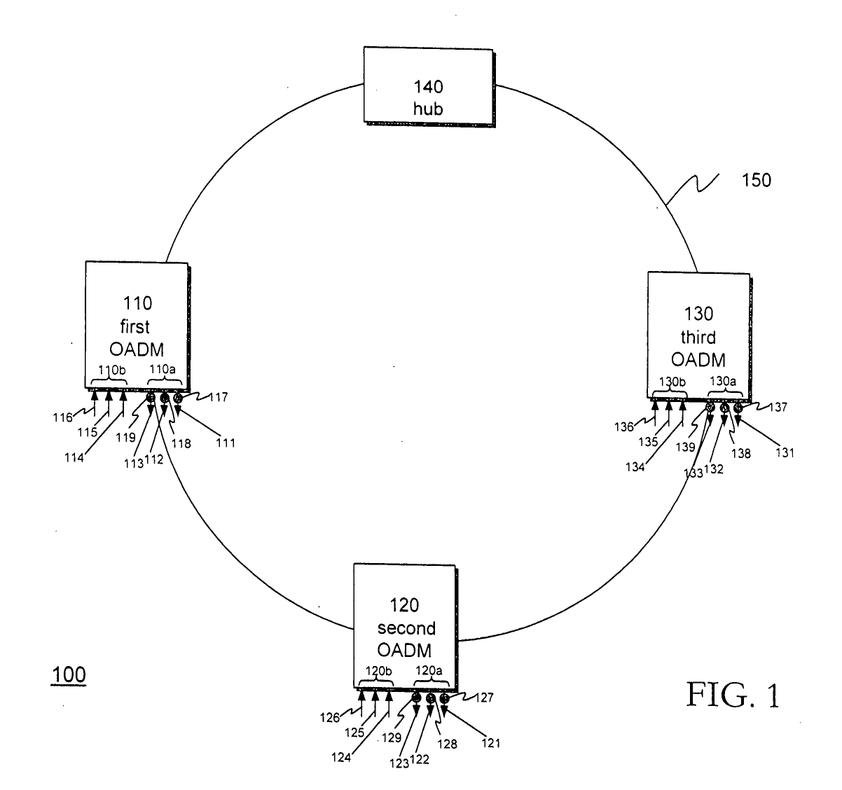

Referring to FIG. 1, there is shown an architectural diagram illustrating the deployment of optical add/drop multiplexers and optical performance monitors in a SONET ring of a metro network 100. The metro network 100 comprises a first OADM 110, a second OADM 120, a third OADM 130, and a hub 140 connected in a SONET ring 150. The first OADM 110 has a demultiplexer 110a with a set of dropped channels 111, 112, and 113, and a multiplexer 110b with a set of added channels 114, 115, and 116. The dropped channel 111 has an optical performance monitor (OPM) 117, the dropped channel 112 has an OPM 118, and the dropped channel 113 has an OPM 119. The second OADM 120 has a demultiplexer 120a with a set of dropped channels 121, 122, and 123, and a multiplexer 120b with a set of added channels 124, 125, and 126. The dropped channel 121 has an OPM 127, the dropped channel 122 has an OPM 128, and the dropped channel 123 has an OPM 129. The third OADM 130 has a demultiplexer 130a with a set of dropped channels 131, 132, and 133, and a multiplexer 130b with a set of added channels 134, 135, and 136. The dropped channel 131 has an OPM 137, the dropped channel 132 has an OPM 138, and the dropped channel 133 has an OPM 139.

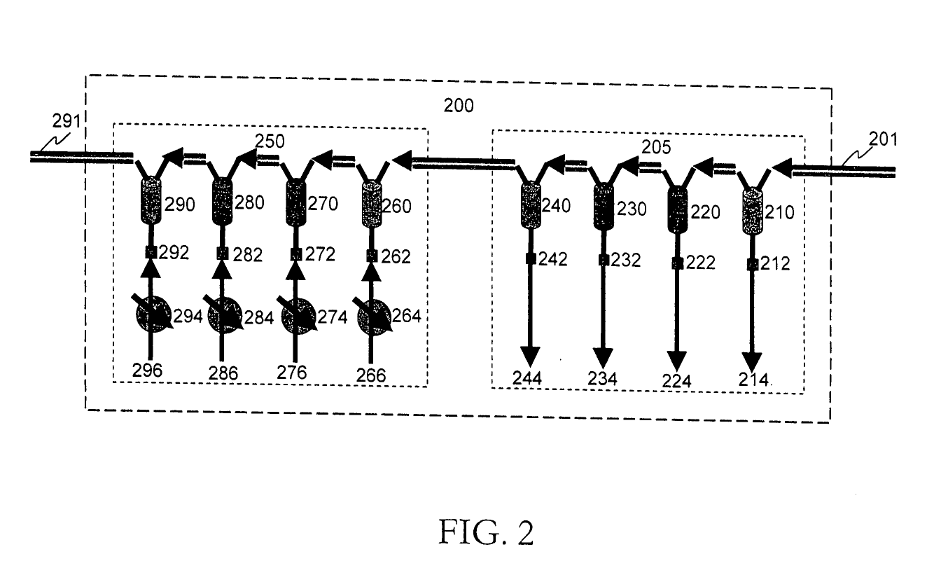

FIG. 2 depicts a block diagram illustrating a smart optical add/drop multiplexer (SOADM) 200 in accordance with the present invention employing performance monitor cells. The SOADM 200 has a demultiplexer 205 coupled to a multiplexer 250 where a fiber input signal 201 is connected into the demultiplexer 205 and the multiplexer 250 generates a fiber output signal 291. The demultiplexer 205 comprises four drop channels 214, 224, 234, and 244 that are connected sequentially. Although four drop channels are shown, the demultiplexer 205 could comprise any number of drop channels. The input signal 201 is delivered to an input of a first filter 210, which in turn is connected to a first performance monitor cell 212 for monitoring the first drop channel 214. The first performance monitor cell 212 has a coupler (not shown) that taps a percentage of the power from the first drop channel 214 for monitoring the power of OSNR at the first drop channel 214. A typical percentage that the coupler taps is about 2-5%.

The first filter 210 is further connected to a second filter 220, which in turn is connected to a second performance monitor cell 222 for monitoring the second drop channel 224. The second filter 220 receives all of the channels of the input signal 201, except for the first drop channel 214, from the first filter 210. The second performance monitor cell 222 has a coupler (not shown) that taps a percentage of the power from the second drop channel 224 for monitoring the power of OSNR at the second drop channel 224. The second filter 220 is further connected to a third filter 230, which in turn is connected to a third performance monitor cell 232 for monitoring the third drop channel 234. The third filter 230 receives all of the channels of the input signal 201, except for the first drop channel 214 and the second drop channel 224, from the second filter 220. The third performance monitor cell 232 has a coupler (not shown) that taps a percentage of the power from the third drop channel 234 for monitoring the power of OSNR at the third drop channel 234. The third filter 230 is further connected to a fourth filter 240, which in turn is connected to a fourth performance monitor cell 242 for monitoring the fourth drop channel 244. The fourth filter 240 receives all of the channels of the input signal 201, except for the first drop channel 214, the second drop channel 224, and the third drop channel 234, from the third filter 230. The fourth performance monitor cell 242 has a coupler (not shown) that taps a percentage of the power from the fourth drop channel 244 for monitoring the power of OSNR at the fourth drop channel 244.

The demultiplexer 205 is coupled to the multiplexer 250. The multiplexer 250 receives all of the channels of the input signal 201, except for the first drop channel 214, the second drop channel 224, the third drop channel 234 and the fourth drop channel 244, from the demultiplexer 205. The multiplexer 250 comprises of four add channels 266, 276, 286, and 296 that are connected sequentially. Although four add channels are shown, the multiplexer 250 could comprise any number of add channels. The first add channel 266 propagates through a first variable optical attenuator (VOA) 264, a fifth performance monitor cell 262, and a fifth filter 260. The second add channel 276 propagates through a second VOA 274, a sixth performance monitor cell 272, and a sixth filter 270. The third add channel 286 propagates through a third VOA 284, a seventh performance monitor cell 282, and a seventh filter 280. The fourth add channel 296 propagates through a fourth VOA 294, an eighth performance monitor cell 292, and an eighth filter 290. The multiplexer 250 generates an output signal 291 that comprises all of the channels delivered to the multiplexer 250 from the demultiplexer 205 as well as the added channels 266, 276, 286 and 296.

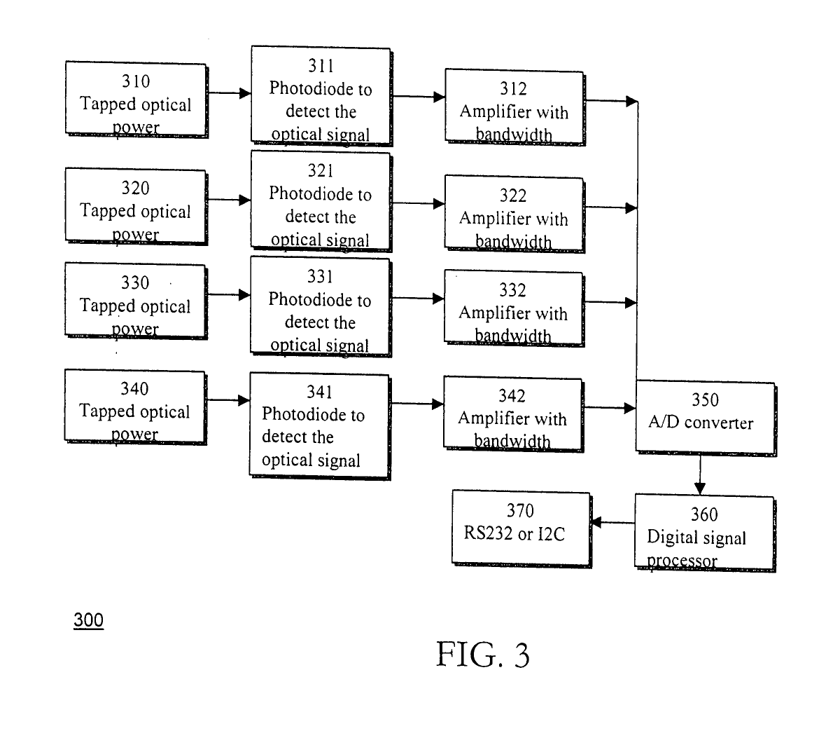

In FIG. 3, there is shown a block diagram illustrating a system 300 in accordance with the present invention that employs four performance monitor cells and the elements therein. In a first path, a photodiode 311 is used to measure a tapped optical power 310. The detected signal from the photodiode 311 is amplified by an amplifier block 312. In one example, a desirable frequency in the amplifier block 312 would be greater than 100 kHz electronic bandwidth to enable the measurement of the electric spectrum up to 100 kHz. An analog-digital (A/D) converter 350 samples the signal at 100 kHz rate from the amplifier 312. A digital signal processor (DSP) 360 processes the sampled data and calculates the channel power value thereby reporting the ONSR through a RS232 or 12C port 370. One of ordinary skill in the art should recognize that the A/D converter 350 and DSP 360 can handle multiple channels.

Similarly, in a second path, a photodiode 321 is used to measure a tapped optical power 320. The detected signal from the photodiode 321 is amplified by an amplifier block 322. In a third path, a photodiode 331 is used to measure a tapped optical power 330. The detected signal from the photodiode 331 is amplified by an amplifier block 332. In a fourth path, a photodiode 341 is used to measure a tapped optical power 340. The detected signal from the photodiode 341 is amplified by an amplifier block 342. The output of each of the amplifiers 312, 322, 332, and 342 is fed into the A/D converter 350.

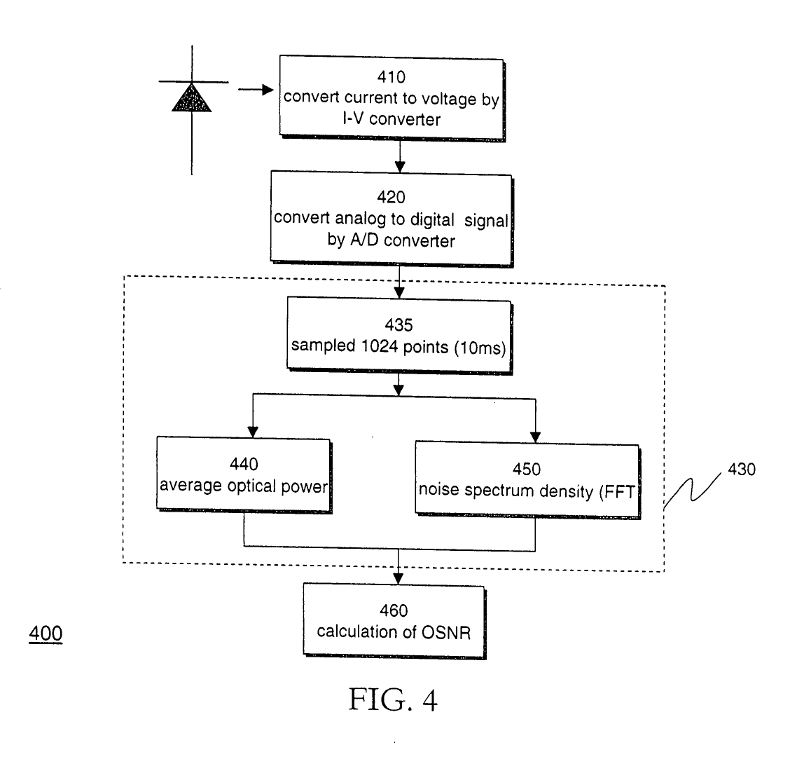

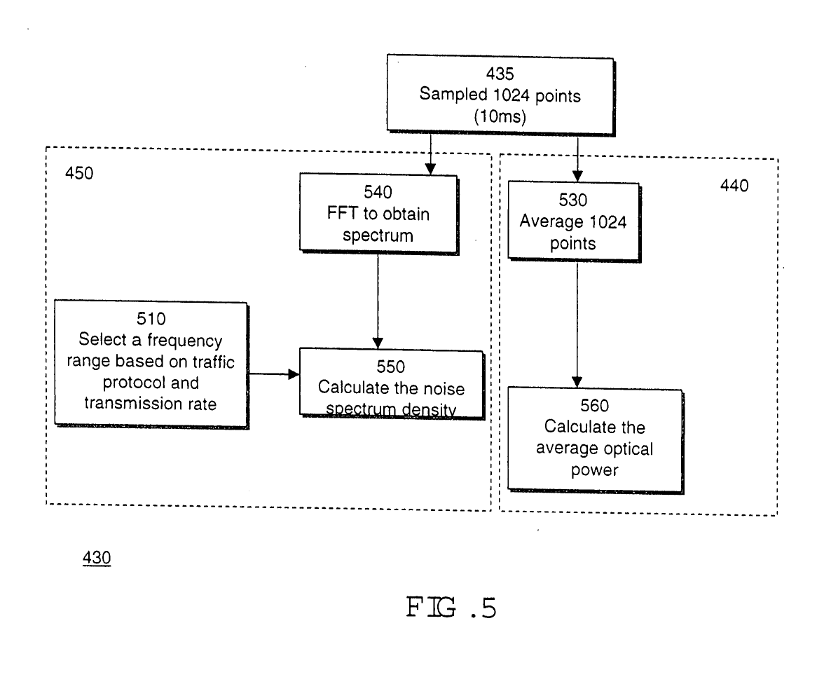

FIG. 4 depicts a general flow diagram illustrating the operational steps in a performance monitor cell 400 in accordance with the present invention. At step 410, the performance cell 400 has an I-V converter for converting a signal from a current to a voltage. The performance monitor cell 400 has an A/D converter for converting an analog voltage to a digital voltage in step 420. At step 435, the performance monitor cell 400 samples 1024 points. At step 440, the performance monitor cell 400 computes the average optical power. At step 450, the performance monitor cell 400 computes the noise power density by taking the Fast Fourier Transform (FFT) of a set of sample points. The steps 435, 440, and 450 are grouped as step 430, which is further described below with respect to FIG. 5. At step 460, the performance monitor cell 400 computes the OSNR for that particular job channel at SOADM.

Turning now to FIG. 5, there is shown a detailed data process flow diagram 430 illustrating the operational steps in computing the OSNR and the average optical power. At step 435, the average optical power is the average of the 1024 sampled points which take, for example, 10 ms to collect. The total sample time is significant. If the sample time is too short, the optical power may become traffic pattern sensitive. For example, if the pattern has long 0 data or long 1 data, then the pattern may cause an unstable power reading. On the other hand, if the sample time is long, the response time will be slow and it is not suitable for close-loop control. For a SONET traffic, one frame has been designed to be 125 microseconds. For a typical optical power monitor of SONET traffic, a power reading average within a 1 ms period is desirable. For the drop channel monitor, the monitor is not used for control. In the case of the drop-channel monitor, a parameter of 10 ms is selected for adapting to the spectrum analysis requirement.

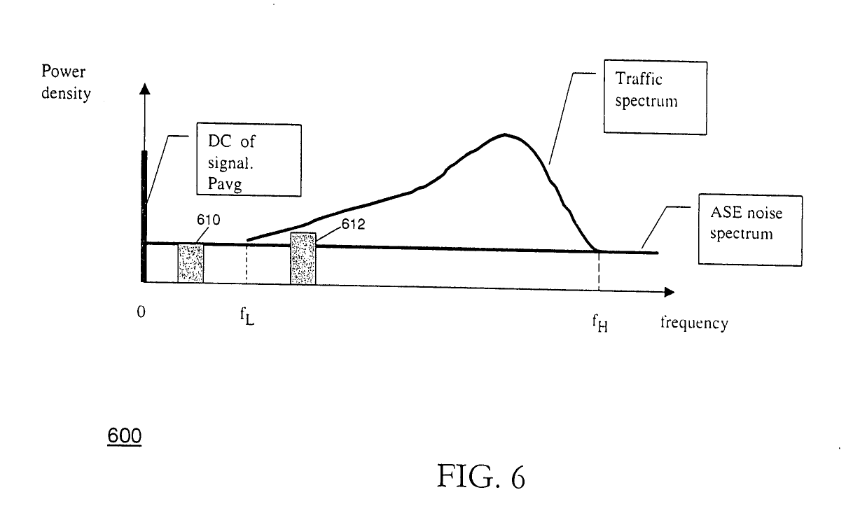

The spectrum could be obtained from 0.1 kHz to 100 kHz from the collected data. However, the frequency range selected in step 510 for calculating the spectrum power density could influence the accuracy. In FIG. 6, the electric spectrum of a channel is shown. The Amplified Spontaneous Emission (ASE) noise includes an “ASE-signal beat noise” and “ASE-ASE beat noise”. The “ASE-signal beat noise” is proportional to the average optical power. If the frequency range to measure the noise power density is within the range f_{L} to f_{H}, the measurement could be traffic pattern sensitive. Therefore, the measurement range below f_{L} is preferred. The parameter f_{L} is transmission rate and protocol dependent. For SONET traffic, the f_{L} is 8 kHz for all transmission rates. In this example, the frequency range selected is between 5 kHz to 7 kHz for calculating the noise power density. This range could change according to the traffic transmission rate and protocol which can be dynamically obtained from the network management system.

At step 510 (FIG. 5), the process selects a frequency range based on the traffic protocol and transmission rate. For example, for the SONET traffic, 6 kHz to 8 kHz can be selected as the range to calculate the noise spectrum density. At step 435, the process 500 samples 1024 points continuously at 100 kHz and it takes about 10 ms. The process 500 computes at step 530 the average of the 1024 points. The process computes at step 540 the Fast Fourier Transform and obtains the spectrum in the frequency domain from 100 Hz to 50 kHz. At step 550, based on the data obtained from step 540 and the frequency range obtained from step 510, the process 500 calculates the noise spectrum density by looking up the pre-saved calibration data, which calibrates the noise spectrum density relative to the total noise in the OSNR. At step 560, the process 500 calculates the optical power from the data of step 530 using a pre-saved calibration table.

The mathematical calculation of the OSNR is described in greater detail below.

Signal-ASE beat noise density
N_{sig-sp}=AP_{sig}Pₐₛₑ
ASE-ASE beat noise density
Nₛₚ₋ₛₚ=AcPₐₛₑPₐₛₑ, c≈0.5
where the symbol A can be determined by experiment, c can be calculated theoretically.
N_{beat}=N_{sig-sp}+Nₛₚ₋ₛₚ
Non beat noise can be measured when setting ASE noise to be zero
Nₜₒₜₐₗ₋ₙₒᵢₛₑ=N_{beat}+N_{non-beat}

Total noise can be obtained by measuring 40 kHz-50 kHz noise spectrum,

$${P}_{avg} = {P}_{sig} + {P}_{ase}$$

$$OSNR = \frac{{p}_{sig}}{{P}_{ase}} \frac{{B}_{o}}{R}$$

where the symbol “P_{sig}” denotes a signal power, the symbol “Pₐₛₑ” denotes an ASE power, the symbol “Bₒ” denotes a filter band width, and the symbol “R” denotes a wavelength resolution (0.1 nm).

FIG. 6 depicts a graphical diagram illustrating the electrical spectrum of an optical channel. The frequency f_{L} represents the lower limit of the traffic spectrum, while the frequency f_{H} represents the higher limit of the traffic spectrum. ASE noise spreads all over the frequency domain. Rectangular-bars 610 and 612 show the frequency range selected to measure the ASE noise. If the ASE noise is measured lower than f_{L}, as is the case with the rectangular bar 610, it will not be affected by the traffic. But if the measurement frequency range is within the traffic spectrum, as is the case with rectangular bar 612, the traffic will affect the OSNR measurement. The DC signal which is the time average of the sampling points reflects the channel optical power.

The distributed optical performance monitor-described above can be implemented in a variety of optical products including Unidirectianal Path Switched Ring (UPSR), Reconfigurable Add/Drop Multiplexer (ROADM), smart OADM, power balanced OADM, fixed OADM, and a transponder.

The above embodiments are only illustrative of the principles of this invention and are not intended to limit the invention to the particular embodiments described. Accordingly, various modifications, adaptations, and combinations of various features of the described embodiments can be practiced without departing from the scope of the invention as set forth in the appended claims.

1. An optical add/drop multiplexer, comprising:
a first performance monitor cell, comprising:
a coupler for tapping a portion of a first optical signal;
a first photodiode for detecting the portion of the first optical signal; and
a first amplifier coupled to the photodiode for amplifying the portion of the first optical signal.

2. The optical add/drop multiplexer of claim 1, further comprising: a second performance monitor cell, coupled to the first performance monitor cell, the second performance monitor cell comprising:
a second coupler for tapping a portion of a second optical signal;
a second photodiode for detecting the portion of the second optical signal; and
a second amplifier coupled to the photodiode for amplifying the portion of the second optical signal.

3. The optical add/drop multiplexer of claim 2, further comprising a third performance monitor cell coupled to the second performance monitor cell, the third performance monitor cell comprising:
a third coupler for tapping a-portion of a third-optical signal;
a third photodiode for detecting the portion of the third optical signal; and
a third amplifier coupled to the photodiode for amplifying the portion of the third optical signal.

4. The optical add/drop multiplexer of claim 3, further comprising a fourth performance monitor cell coupled to the third performance monitor cell, the fourth performance monitor cell comprising:
a fourth coupler for tapping a portion of a fourth optical signal;
a fourth photodiode for detecting the portion of the fourth optical signal; and
a fourth amplifier coupled to the photodiode for amplifying the portion of the fourth optical signal.

5. The optical add/drop multiplexer of claim 4, further comprising a first filter coupled between the first performance monitor cell and the second performance monitor cell.

6. The optical add/drop multiplexer of claim 5, further comprising a second filter coupled between the first filter and the second performance monitor cell.

7. An optical add/drop multiplexer, comprising:
a demultiplexer connected to an input fiber, the demultiplexer comprising a first performance monitor cell for monitoring a first drop channel and a second performance monitor cell for monitoring a second drop channel, wherein each performance monitor cell in the demultiplexer includes a coupler, a first photodiode and a first amplifier; and
a multiplexer connected to an output fiber, the multiplexer comprising a first performance monitor cell for monitoring a first add channel and a second performance monitor cell for monitoring a second add channel, wherein each performance monitor cell in the multiplexer is optically connected to a respective variable optical attenuator.

8. The optical add/drop multiplexer of claim 7, wherein the demultiplexer further includes a third and a fourth monitor cell.

9. The optical add/drop multiplexer of claim 7, wherein the multiplexer further includes a third and a fourth monitor cell.

10. The optical add/drop multiplexer of claim 7, further comprising a first filter coupled between the first performance monitor cell and the second performance monitor cell.

11. The optical add/drop multiplexer of claim 10, further comprising a second filter coupled between the first filter and the second performance monitor cell.

12. The optical add/drop multiplexer of claim 7, wherein the photodiode in each performance monitor cell is configured to measure a taped optical power.

13. The optical add/drop multiplexer of claim 12, wherein the amplifier in each performance monitor cell is configured to amplifying the taped optical power.
